(19) United States
(12) Patent Application Publication
(10) Pub. No.: US 2005/0278767 A1
(43) Pub. Date: Dec. 15, 2005

(54) Computer-telephony integrated entertainment system

(76) Inventor: Devinder S. Ahluwalia, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/856,078

(22) Filed: May 28, 2004

(51) Int. Cl. H04N 7/173; H04N 7/16; H04J 11/00

(52) U.S. Cl. 725/109; 725/106; 725/133; 725/141; 725/153; 725/5

(57) ABSTRACT

Method and apparatus for a system to perform television and telephony operations are described.

### BACKGROUND

A media computer may provide various functions for an entertainment system, such as when connected to a television system. For example, the media computer may receive and decode video signals for display on the television. In another example, the media computer may simultaneously display graphics and video on the television, such as drawing a transparent or translucent graphic over a video image. The media computer, however, is typically directed to handling television signals to enhance viewing services. Conventional telephony services have yet to be seamlessly integrated with such viewing services. Accordingly, there may be a need for improvements in such techniques in a device or network.

### BRIEF DESCRIPTION OF THE DRAWINGS

FIG. 1 illustrates a block diagram of a system 100;

FIG. 2 illustrates a block diagram of a media computer 200;

FIG. 3 illustrates a block diagram of a television system 300;

FIG. 4 illustrates a block diagram of a remote control unit 400;

FIG. 5 illustrates a block diagram of a processing logic 500; and

FIG. 6 illustrates a block diagram of a processing logic 600.

### DESCRIPTION OF SPECIFIC EMBODIMENTS

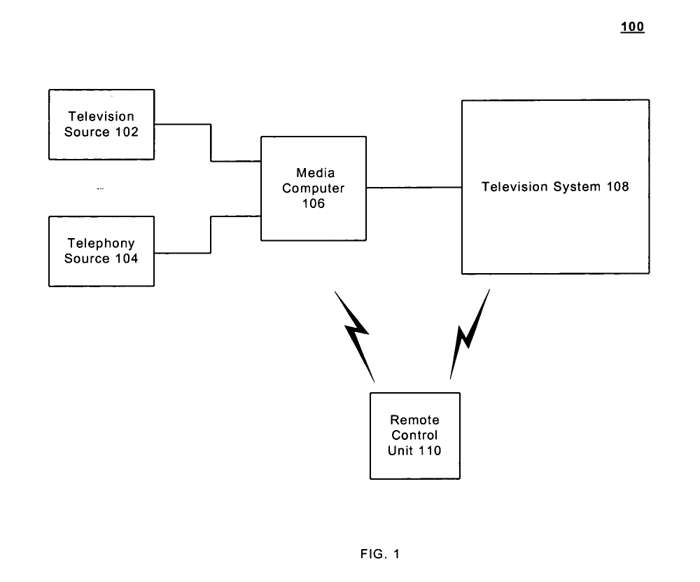

FIG. 1 illustrates a block diagram of a system 100. System 100 may comprise a communication system to communicate information between multiple nodes. A node may comprise any physical or logical entity having a unique address in system 100. The unique address may comprise, for example, a network address such as an Internet Protocol (IP) address, device address such as a Media Access Control (MAC) address, and so forth. In one embodiment, for example, system 100 may comprise a television source 102, a telephony source 104, an entertainment computer 106, a television system 108, and a remote control unit 110. Although FIG. 1 shows a limited number of nodes, it can be appreciated that any number of nodes may be used in system 100. The embodiments are not limited in this context.

The nodes of system 100 may be arranged to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

Referring again to FIG. 1, system 100 may comprise television source 102. Television source 102 may comprise any television source arranged to source standard analog television signals, digital television signals, or high definition television (HDTV) signals. The television signals may include various types of information, such as audio information, video information, and control information. The video information may include content from a video program, computer generated images (CGI), and so forth. The audio information may include voices, music, sound effects, and so forth. Examples of television source 102 may include any device arranged to deliver pre-recorded media stored in various formats, such as a Digital Video Disc (DVD) device, a VHS device, a computer, a gaming console, and so forth. Television source 102 may also include multimedia distribution systems to provide broadcast or streaming analog or digital television signals to media computer 106. Examples of multimedia distribution systems may include, for example, Over The Air (OTA) broadcast systems, terrestrial cable systems (CATV), satellite broadcast systems, and so forth. The types and locations of television source 102 are not limited in this context.

In one embodiment, system 100 may comprise telephony source 104. Telephony source 104 may comprise any telephony source arranged to source standard analog telephony signals. The telephony signals may include various types of information, such as audio information and control information. The audio information may include any information typically conveyed during a telephone call, such as speech, speech utterances, music, background noise, and so forth. The control information may include call control information, such as instructions to set up and tear down a call connection for a call session, e.g., a telephone call. For example, the call information may instruct a telephone to deliver a dial tone, communicate dual-tone multiple frequencies (DTMF) digits, ring tones, establish a call connection, terminate a call connection, and a so forth.

In one embodiment, for example, telephone source 104 may comprise a telephone network, such as the Public Switched Telephone Network (PSTN). Typically, the PSTN may comprise a series of communication nodes connected by various communications media, which eventually terminates at a physical location, such as a demarcation point for a home or office. An example of the communication node may comprise a Central Office (CO) having one or more switches of varying capacities. The CO may be connected to the demarcation point using a category five twisted-pair copper wire, co-axial cable, fiber optic cable, and so forth. From the demarcation point, the home or office may be wired to various locations within the structure, terminating in various local access panels with wall plates and a physical connector, such as an RJ-45 plug. A user connects a telephone to the local access panel using twisted-pair wire with a matching physical connector.

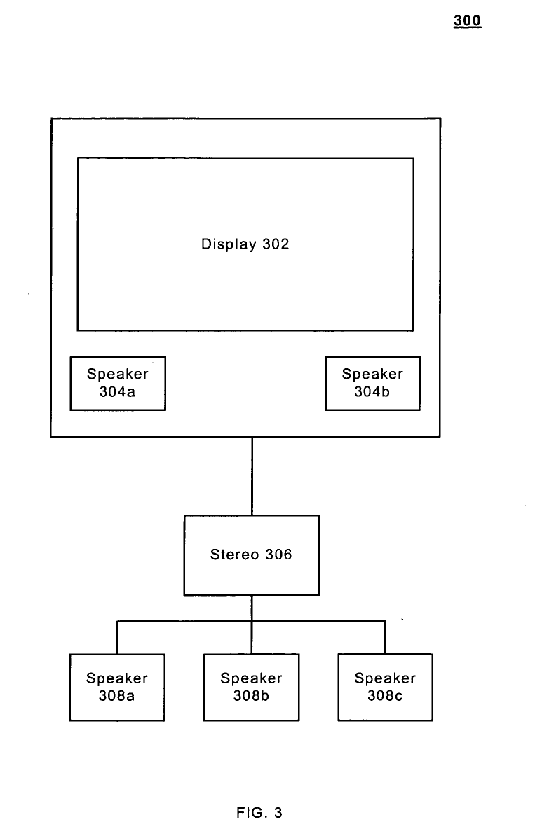

In one embodiment, system 100 may comprise television system 108. Television system 108 may comprise any conventional television having a display and speakers. Television system 108 may also include an external audio system, such as a receiver or tuner connected to external speakers. Television system 108 may be discussed in more detail with reference to FIG. 3.

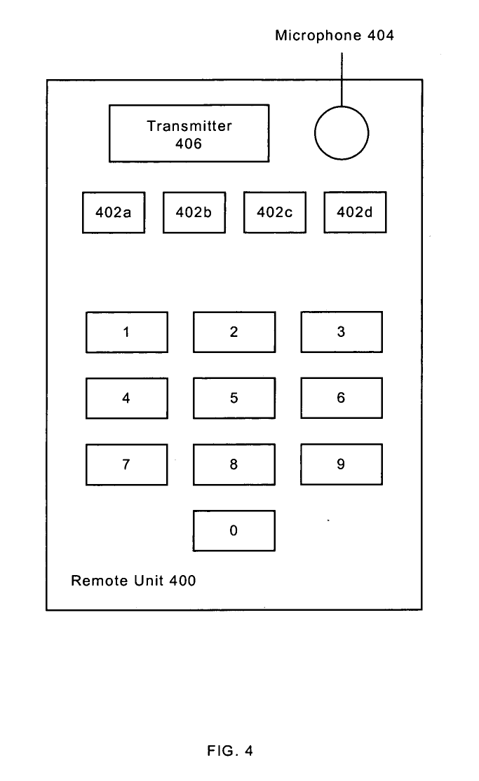

In one embodiment, system 100 may comprise remote control unit 110. Remote control unit 110 may be a remote control unit arranged to operate with television system 108 in a conventional manner. In addition, remote control unit 110 may be arranged with additional transmitters and control logic to communicate with media computer 106 over a wireless communications medium using RF or Infrared (IR) signals. Remote control unit 110 may be discussed in more detail with reference to FIG. 4.

In one embodiment, system 100 may comprise media computer 106. Media computer 106 may comprise a personal computer (PC) arranged to manage media information and control information for the various nodes of system 100. Media computer 106 may be connected to television source 102, telephony source 104, television system 108, and remote control unit 110. The connections may include various wired or wireless communications media and the appropriate input/output (I/O) adapters.

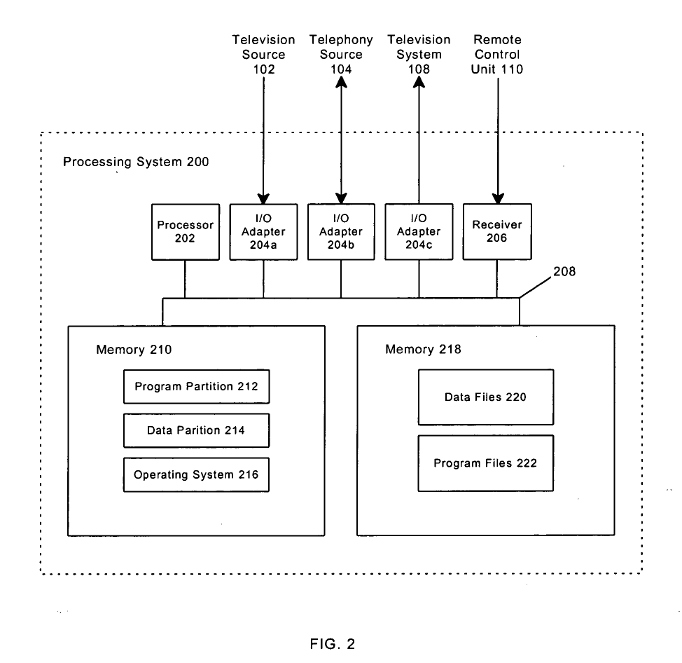

In one embodiment, media computer 106 may be operable to receive television signals from television source 102. Media computer 106 may forward the television signals to television system 108 to reproduce the television signals. Media computer 106 may also receive telephony signals from telephony source 104. Media computer 106 may communicate the telephony signals to a user via a display and one or more speakers for television system 108. A user may communicate telephony signals to media computer 106 via remote control unit 110. In this manner, media computer 106 may be used to integrate television and telephony operations in a single system. As a result, a user may have added convenience leading to a more desirable entertainment experience. Media computer 106 may be discussed in more detail with reference to FIG. 2.

FIG. 2 illustrates a media computer 200. Media computer 200 may be representative of, for example, an implementation for media computer 106 described with reference to FIG. 1. Media computer 200 may comprise a processing system arranged to implement operations for the various embodiments as software executed by a processor. It may be appreciated, however, that the embodiments may be implemented using hardware circuits or structures, or a combination of hardware and software, as desired for a particular implementation. The embodiments are not limited in this context.

In one embodiment, media computer 200 may include a processor 202, multiple I/O adapters 204a-c, a receiver 206, a memory 210 and disk storage 218. One or more of these elements are interconnected by bus 208, which allows data to be intercommunicated between the elements. Although media computer 200 is shown with a limited number of elements for purposes of clarity, it may be appreciated that other elements may be added to media computer 200. For example, media computer 200 may have a display unit, keyboard, mouse, printer, external drives, and so forth, with the appropriate I/O adapters for each. The embodiments are not limited in this context.

In one embodiment, media computer 200 may comprise processor 202. Processor 202 can be any type of processor capable of providing the speed and functionality desired for an embodiment. For example, processor 202 could be a processor made by Intel® Corporation and others. Processor 202 may also comprise a digital signal processor (DSP) and accompanying architecture, such as a DSP from Texas Instruments Incorporated. Processor 202 may further comprise a dedicated processor such as a network processor, embedded processor, micro-controller, controller and so forth.

In one embodiment, memory 210 and disk storage 218 may comprise any machine-readable media capable of storing program instructions and data adapted to be executed by a processor. Some examples of machine-readable media include, but are not limited to, read-only memory (ROM), random-access memory (RAM), dynamic RAM (DRAM), double DRAM (DDRAM), static RAM (SRAM), programmable ROM, erasable programmable ROM, electronically erasable programmable ROM, dynamic RAM, magnetic disk (e.g., floppy disk and hard drive), optical disk (e.g., CD-ROM) and any other media that may store digital information. Further, media computer 200 may contain various combinations of machine-readable storage devices through various I/O controllers, which are accessible by processor 202 and which are capable of storing a combination of computer program instructions and data.

In one embodiment, the term “program instructions” may include computer code segments comprising words, values and symbols from a predefined computer language that, when placed in combination according to a predefined manner or syntax, cause a processor to perform a certain function. Examples of a computer language may include C, C++, JAVA, assembly and so forth. The instructions may be stored on the media in a compressed and/or encrypted format. As used herein, the phrase “adapted to be executed by a processor” is meant to encompass instructions stored in a compressed and/or encrypted format, as well as instructions that have to be compiled or installed by an installer before being executed by processor 202.

In one embodiment, memory 210 is accessible by processor 202 over bus 208 and includes a program partition 212, a data partition 214, and an operating system 216. An example of operating system 216 may comprise an operating system sold by Microsoft Corporation, such as Microsoft Windows' 95, 98, 2000 and XP, for example. Program partition 212 stores and allows execution by processor 202 of program instructions that implement the functions of each respective system described herein. Data partition 214 is accessible by processor 202 and stores data used during the execution of program instructions.

In one embodiment, program partition 212 contains program instructions that will be collectively referred to herein as a media management module and a graphics overlay module. Although the embodiment has been described in terms of “modules” to facilitate description, one or more circuits, components, registers, processors, software subroutines, or any combination thereof could be substituted for one, several, or all of the modules. Of course, the scope of the embodiments is not limited to this particular set of instructions.

In one embodiment, program partition 212 may comprise a media management module to manage television signals for television system 108. The media management module may be arranged to receive television signals from television source 102 via a television source interface, such as I/O adapter 204a. The media management module may perform various processing operations for the television signals, such as decoding audio and video information, decompressing audio and video information, adding latency to the audio and video information, storing the audio and video information, and so forth. Once media management module has finished processing the television signal, it may forward the processed signal to television system 108 via a television system interface, such as I/O adapter 204c. Media management module may also be arranged in a pass-through mode where the television signals are passed to television system 108 via I/O adapter 204c without any pre-processing.

In one embodiment, the media management module may also perform call processing for media computer 200. For example, the media management module may establish and terminate a call connection for a call session between media computer 200 and an external endpoint, such as a telephone connected to telephony source 104. An example of a call session may comprise a telephone call. The media management module may communicate telephony signals with telephony source 104 via a telephony interface, such as I/O adapter 204b. Once media management module establishes a call connection between the telephone and media computer 200, media management module may begin communicating audio information over the call connection.

In one embodiment, media computer 200 may comprise receiver 206. Receiver 206 may be arranged to receive call control information and audio information from a remote control unit, such as remote control unit 110. Receiver 206 may comprise any receiver system configured to receive RF signals from a transmitter at a predetermined operating frequency. For example, receiver 206 may comprise conventional amplifying and signal-processing circuits, such as band pass filters, mixers, and amplifier circuits. In addition, receiver 206 may comprise an output stage connected to the media management module via bus 208. The operating frequency may vary according to a given implementation. For example, the operating frequency may comprise a frequency in the RF spectrum, to include the IR range, the microwave range, VHF, UHF, or other frequencies along the electromagnetic spectrum. The embodiments are not limited in this context.

In one embodiment, I/O adapters 204a-c may each comprise any network adapter or network interface card (NIC) arranged to operate in accordance with a desired set of communications protocols, services and operating procedures, for example. In one embodiment, for example, I/O adapters 204a and 204b represent network interfaces suitable to connect to television source 102 and telephony source 104, respectively. I/O adapter 204c may represent a network interface suitable to connect to television system 108. I/O adapters 204a-c may also include the appropriate connectors for connecting with a given communications medium, such as metal leads, semiconductor material, twisted-pair wire, co-axial cable, fiber optics, RF spectrum, and so forth.

In one embodiment, program partition 212 may include a graphics overlay module. Graphics overlay module may receive, store and manage overlay information for use in simultaneously displaying graphics and video on a television display, such as drawing a transparent or translucent graphic over a video image. An example of overlay information may be a translucent list of menu items for a control feature for a television that is displayed over a video program, a picture-in-picture (PIP) box to view simultaneous video programs, and so forth.

In one embodiment, the media management module may generate a message for display by television system 108. For example, during an incoming call the media management module may generate an incoming call message. During an outgoing call, the media management module may generate an outgoing call message. The content of each message may vary, but typically includes such information as a name, number, date, time, and so forth. The embodiments are not limited in this context.

In one embodiment, the graphics overlay module may receive the message from the media management module in the form of overlay information. The overlay information may comprise graphics planes G1 and alpha planes A1. The graphics plane may comprise two or three dimensional graphics specifying a color definition utilizing three components, such as red, green, blue (RGB). The red, green and blue components may represent actual colors. The alpha plane may comprise alpha (A) components. The alpha components may represent a blending factor to indicate a level of transparency for the overlay information. In one embodiment, the combined RGBA information may be stored using 32 bits per pixel, 8 bits for each R, G, B and A components, for example. The graphics plane may also be represented utilizing other color space coding techniques, such as Y′C_{B}C_{R}, for example.

In one embodiment, the graphics overlay module may be arranged to receive a video plane from a television signal by a television source interface, such as I/O adapter 204a. The graphics overlay module may generate an overlay plane using the overlay information and the message received from the media management module. The graphics overlay module may blend the video plane with the overlay plane to form a blended frame. Graphics overlay module may send the blended frame to television system 108 using I/O adapter 204c. Television system 108 may then display the blended frame on its display.

The graphics overlay module may be advantageous when television system 108 does not have graphics overlay capabilities. If television system 108 includes graphics overlay capabilities, however, the graphics overlay module of media computer 200 may be omitted from media computer 200, or may have its functionality disabled or deactivated. The embodiments are not limited in this context.

In general operation, media computer 200 may operate to integrate television and telephony management operations in a single system. As described with reference to FIG. 1, media computer 200 may be operable to receive television signals from television source 102. Media computer 200 may forward the television signals to television system 108 to reproduce the television signals. In addition, media computer 200 may also receive telephony signals from telephony source 104. Media computer 106 may communicate the telephony signals to a user via a display and one or more speakers for television system 108. A user may communicate telephony signals to media computer 106 via remote control unit 110.

In one embodiment, for example, the media management module may receive a call request from a telephone from telephony source 104 via I/O adapter 204b. The media management module may initiate operations to setup a call connection between media computer 200 and the external telephone. Media management module may send an incoming call message to a display for television system 108. A user may determine whether to answer the call using remote control 110. If the user desires to accept the call, the user may press the appropriate button or sequence of buttons to send a call accept message from remote control 110. Receiver 206 may receive the call accept message and forward it to the media management module. The media management module may then forward the call accept message to telephony source 104 via I/O adapter 204b. A call connection may then be completed by telephony source 104 in a conventional manner. Once the call connection is established, the media management module may send a mute message to television system 108 via I/O adapter 204c to mute audio information from the television signal being reproduced by television system 108.

FIG. 3 illustrates a block diagram of a television system 300. Television system 300 may be representative of, for example, television system 108. As shown in FIG. 3, television system 300 may comprise a display 302, speakers 304a and 304b, a stereo 306, and speakers 308a-c. In a normal television mode of operation, media computer 200 may send television signals to television system 300. Television system 300 may reproduce the video information using display 302. Television system 300 may reproduce the audio information from the television signals using speakers 304a-b. Alternatively, television system 300 may reproduce the audio information using speakers 308a-c via stereo 306. Stereo 306 may comprise a tuner and/or amplifier to control speakers 308a-c.

In addition to television mode of operation, media computer 200 and television system 300 may be used for telephony operations. For example, when setting up a call connection, the media management module may send an incoming call message for display by television system 300. Once the call connection has been established, the media management module may receive audio information from telephony source 104 via I/O adapter 204b, and send the audio information to television system 300. Television system 300 may reproduce the audio information using one or more speakers 304a-b and/or 308a-c for television system 300. In this manner, a user may hear the audio information from a telephone call in a manner similar to a speaker phone.

FIG. 4 illustrates a block diagram of a remote control unit 400. Remote control unit 400 may be representative of, for example, remote control unit 110 described with reference to FIG. 1. As shown in FIG. 4, remote control unit 400 may comprise a set of telephony control buttons 402a-d, a microphone 404, a transmitter 406, and alphanumeric buttons 0-9. Remote control unit 400 may have additional buttons or controls to provide normal television operations, such as volume, channel, power, and so forth. The embodiments are not limited in this context.

In one embodiment, remote control 400 may include microphone 404. Microphone 404 may be any microphone arranged to capture sound waves and generating an analog or digital audio signal. Microphone 404 may be in electrical communication with a microphone button 402d, which toggles operation of microphone 400 in one implementation. Alternatively, microphone 404 may be activated or deactivated in accordance with a call accept message as discussed in more detail below.

In one embodiment, remote control 400 may include transmitter 406. Transmitter 406 may transmit audio information from microphone 404 to receiver 206 of media computer 200. Transmitter 406 may comprise any transmitter system configured to transmit an electromagnetic signal, such as a RF signal at a desired operating frequency. Transmitter 406 may comprise a transmitter antenna operatively coupled to an output stage. The output stage may comprise various conventional driving and amplifying circuits, including a circuit to generate an electric current. When the electric current is supplied to the transmitter antenna, the transmitter antenna may generate electromagnetic signals around the transmitter antenna at or around the operating frequency. The electromagnetic signals may propagate from remote control unit 400 to receiver 206 of media computer 200. Transmitter 406 and receiver 206 may operate using any desired frequency band, such as frequency band within the 890-960 MHz range (GSM), 1990-2110 MHz range, 2400-2500 MHz range, or other frequency ranges as approved by FCC regulations. The selected frequency band should provide sufficient bandwidth to provide real time communications in accordance with a desired set of telephony quality and latency parameters.

In one embodiment, transmitter 406 and receiver 206 may both be configured to communicate audio information and control information in accordance with one or more protocols. A protocol may comprise a set of predefined rules or instructions to control how the nodes communicate information between each other. The protocol may be defined by one or more protocol standards, such as the standards promulgated by the Internet Engineering Task Force (IETF), International Telecommunications Union (ITU), a company such as Intel® Corporation, and so forth. An example of a suitable protocol may comprise a protocol from the IEEE 802.11 family of protocols, the Bluetooth protocol, and so forth. Transmitter 406 and receiver 206 may also communicate using a conventional wireless telephone protocol, such as a used with conventional wireless telephones. The embodiments are not limited in this context.

In one embodiment, transmitter 406 may be configured to broadcast digital signals. As such, transmitter 406 may include an analog-to-digital converter (A/D) to convert analog audio signals from microphone 404 into digital information. The embodiments may be implemented using analog or digital transmissions from remote control 400, as desired for a given implementation.

In one embodiment, remote control unit 400 may comprise telephony control buttons 402a-d. Each telephony control button may correspond to different control information for telephony operations. For example, one or more telephony control buttons 402a-d may be programmed to send control information to indicate acceptance of an incoming call, rejection of an incoming call, initiating an outgoing call, activate/deactivate microphone 404, and so forth. Although only a limited number of telephony control buttons are shown by way of example, it can be appreciated that any number of telephony control buttons or sequence of button operations may be used for any number of telephony operations. The embodiments are not limited in this context.

In general operation, the media management module of media computer 200 and remote control unit 400 may be combined to perform telephony operations in a manner similar to a telephone. For example, when a call request is received by media computer 200, the media management module may generate an incoming call message for display by display 302 of television system 300. The incoming call message may include, for example, a telephone number, a caller's name, a date, a time, graphics, images, photos, and so forth. A user may see the displayed incoming call message, and determine whether the user would like to answer the call. If the user wants to accept the call, the user may press the corresponding telephony control button 402a to send a call accept message to the media management module via transmitter 406. The media management module may receive the call accept message, mute the television and complete the call connection. If the user wants to reject the call, the user may press the corresponding telephony control button 402b to send a call reject message to the media management module. The media management module may receive the call reject message, remove the incoming call message from display 302, and terminate the call or forward the call to another device such as an answering machine.

To initiate a telephone call, a user may press the corresponding telephony control button 402c to initiate a telephone call. Telephony control button 402c may instruct transmitter 406 to transmit key presses from keys 0-9. Receiver 206 may begin receiving the numbers, and recognize that a telephone number is being received. Receiver 206 may forward the received numbers to the media management module. Media management module may send an outgoing call message to television system 300 for display on display 302. In this manner, the user may view the numbers as they are dialed, and may be informed of the current status of the outgoing call request. Once the media management module receives the seven or ten digit telephone number, the media management module may generate a call request using the telephone number. The media management module may send the request to telephony source 104 via I/O adapter 204b. If the telephone corresponding to the telephone number is answered, a call connection may be completed between the telephone and the media management module. The media management module may then instruct television system 300 to remove the outgoing call message, and to mute the television so that the user may begin conversing using the call connection.

Once a call connection has been established, audio information may be reproduced from the telephone using speakers 304a-b and/or speakers 308a-c of television system 300. In this manner, the user may hear audio information from the other party. The user may speak into microphone 404, which captures sound waves and generates an analog or digital audio signal. Microphone 404 may be activated when a call accept message is sent via telephony control button 402a, or when a user presses a separate telephony control button such as microphone button 402d. Transmitter 406 may transmit the audio information from the user to media computer 200.

Operations for the above systems may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

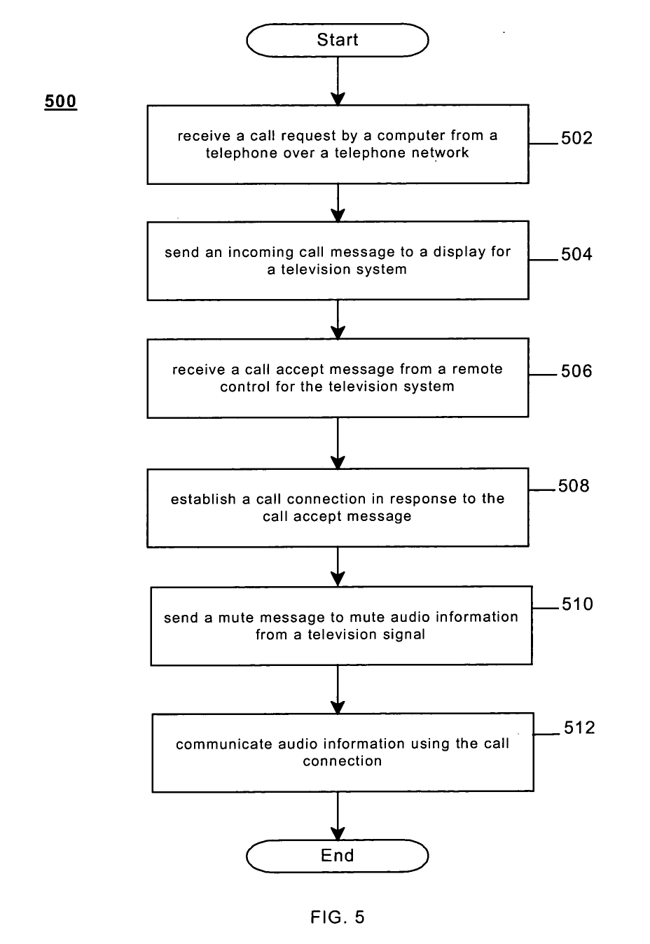

FIG. 5 illustrates a block diagram for a programming logic 500. FIG. 5 illustrates a programming logic 500 that may be representative of the operations executed by one or more systems described herein, such as systems 100-400. As shown in programming logic 500, a call request may be received by a computer from a telephone over a telephone network at block 502. An incoming call message may be sent to a display for a television system at block 504. A call accept message may be received from a remote control for the television system at block 506. A call connection may be established in response to the call accept message at block 508. A mute message may be sent to the television system to mute audio information from a television signal at block 510. Audio information may be communicated using the call connection at block 512.

In one embodiment, audio information may be communicated using the call connection by receiving audio information at a microphone for the remote control. Audio information may be sent to the computer using a transmitter. The audio information may be sent from the computer to the telephone.

In one embodiment, audio information may be communicated using the call connection by receiving audio information at the computer from the telephone. The audio information may be sent to a speaker for the television system. The audio information may be reproduced using the speaker.

In one embodiment, the incoming call message may be sent by receiving a video plane from a television signal by the computer. An overlay plane may be generated with the incoming call message. The video plane may be blended with the overlay plane to form a blended frame. The blended frame may be sent to the display for the television system.

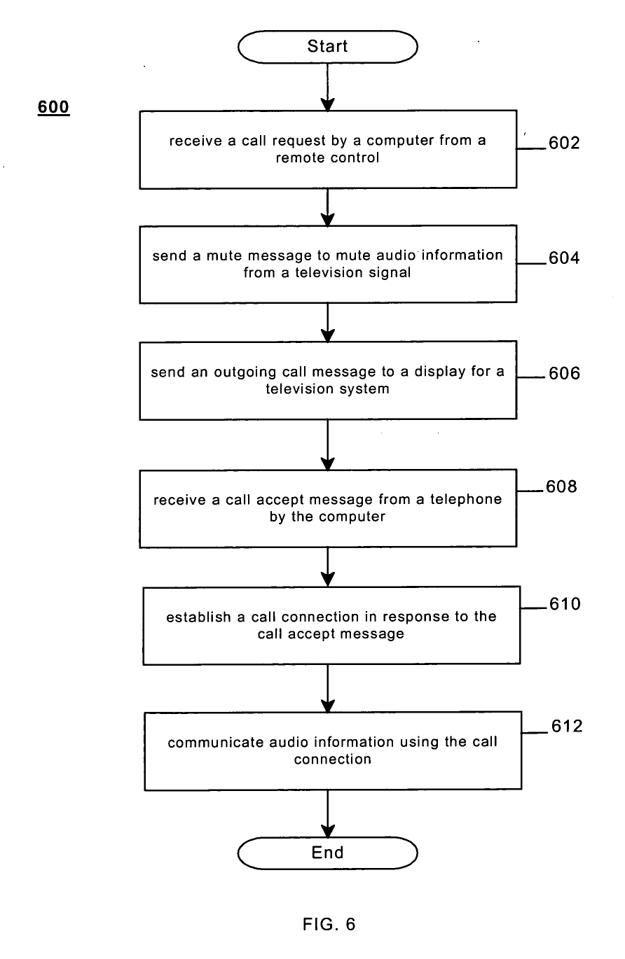

FIG. 6 illustrates a block diagram for a programming logic 600. FIG. 6 illustrates a programming logic 600 that may be representative of the operations executed by one or more systems described herein, such as systems 100-400. As shown in programming logic 600, a call request may be received by a computer from a remote control at block 602. A mute message may be sent to mute audio information from a television signal at block 604. An outgoing call message may be sent to a display for a television system at block 606. A call accept message may be received from a telephone by the computer at block 608. A call connection may be established in response to the call accept message at block 610. Audio information may be communicated using the call connection at block 612.

In one embodiment, audio information may be communicated using the call connection by receiving audio information at a microphone for the remote control. The audio information may be sent to the computer using a transmitter. The audio information may be sent from the computer to the telephone.

In one embodiment, audio information may be communicated using the call connection by receiving audio information at the computer from the telephone. The audio information may be sent to a speaker for the television system. The audio information may be reproduced using the speaker.

In one embodiment, the outgoing call message may be sent by receiving a video plane from a television signal by the computer. An overlay plane may be generated with the outgoing call message. The video plane may be blended with the overlay plane to form a blended frame. The blended frame may be sent to the display for the television system.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

All or portions of an embodiment may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a processor. In another example, an embodiment may be implemented as dedicated hardware, such as a circuit, an application specific integrated circuit (ASIC), Programmable Logic Device (PLD), DSP, and so forth. In yet another example, an embodiment may be implemented by any combination of programmed general-purpose computer components and custom hardware components. The embodiments are not limited in this context.

1. A method, comprising:
receiving a call request by a computer from a telephone over a telephone network;
sending an incoming call message to a display for a television system;
receiving a call accept message from a remote control for said television system;
establishing a call connection in response to said call accept message;
sending a mute message to mute audio information from a television signal; and
communicating audio information using said call connection.

2. The method of claim 1, wherein said communicating comprises:
receiving audio information at a microphone for said remote control;
sending said audio information to said computer using a transmitter; and
sending said audio information from said computer to said telephone.

3. The method of claim 1, wherein said communicating comprises:
receiving audio information at said computer from said telephone;
sending said audio information to a speaker for said television system; and
reproducing said audio information using said speaker.

4. The method of claim 1, wherein sending said incoming call message comprises:
receiving a video plane from a television signal by said computer;
generating an overlay plane with said incoming call message;
blending said video plane with said overlay plane to form a blended frame; and
sending said blended frame to said display for said television system.

5. A method, comprising:
receiving a call request by a computer from a remote control;
sending a mute message to mute audio information from a television signal;
sending an outgoing call message to a display for a television system;
receiving a call accept message from a telephone by said computer;
establishing a call connection in response to said call accept message; and
communicating audio information using said call connection.

6. The method of claim 5, wherein said communicating comprises:
receiving audio information at a microphone for said remote control;
sending said audio information to said computer using a transmitter; and
sending said audio information from said computer to said telephone.

7. The method of claim 5, wherein said communicating comprises:
receiving audio information at said computer from said telephone;
sending said audio information to a speaker for said television system; and
reproducing said audio information using said speaker.

8. The method of claim 5, wherein sending said outgoing call message comprises:
receiving a video plane from a television signal by said computer;
generating an overlay plane with said outgoing call message;
blending said video plane with said overlay plane to form a blended frame; and
sending said blended frame to said display for said television system.

9. An apparatus, comprising:
a media management module to perform call processing for a computer;
a telephone interface to couple to said media management module, said telephone interface to communicate call control information between a telephone and said media management module over a telephone network;
a television interface to couple to said media management module, said television interface to communicate call control information and television signals to a television system;
a receiver to couple to said media management module, said receiver to receive call control information and audio information from a remote control; and
wherein said media management module is to establish a call connection between said telephone and said media management module, and communicate audio information using said call connection.

10. The apparatus of claim 9, wherein said telephone interface is to receive a call request from a telephone over a telephone network, said television interface is to send an incoming call message to a display for said television system, said receiver is to receive a call accept message from a remote control, and said media management module is to send a mute message to mute audio information from a television signal using said television interface.

11. The apparatus of claim 9, wherein said remote control includes a microphone and a transmitter, with said microphone to receive audio information, said transmitter to send said audio information to said receiver, said receiver is to receive said audio information and send said audio information to said media management module, and said media management module is to send said audio information to said telephone using said telephone interface.

12. The apparatus of claim 9, wherein said media management module is to receive audio information from said telephone interface, and send said audio information to a speaker for said television system.

13. The apparatus of claim 9, further comprising a graphics overlay module to connect to said media management module, said graphics overlay module to receive a video plane from a television signal by said television interface, generate an overlay plane with said incoming call message, blend said video plane with said overlay plane to form a blended frame, and send said blended frame to said display for said television system using said television interface.

14. The apparatus of claim 9, wherein said receiver is to receive a call request from said remote control, said media management module is to send a mute message to mute audio information from said television signal and an outgoing call message to a display for said television system, said media management module to further receive a call accept message from a telephone by said telephone interface and establish said call connection in response to said call accept message.

15. A system, comprising:
a television system having a display and a speaker;
an entertainment computer to connect to said television system; and
a remote control unit having a microphone, a transmitter, and a set of control buttons, said control buttons to generate call control information, said microphone to receive audio information, and said transmitter to transmit said call control information and said audio information to said entertainment computer.

16. The system of claim 15, wherein said entertainment computer comprises:
a media management module to perform call processing;
a telephone interface to couple to said media management module, said telephone interface to communicate call control information between a telephone and said media management module over a telephone network;
a television interface to couple to said media management module, said television interface to communicate call control information and television signals to said television system;
a receiver to couple to said media management module, said receiver to receive call control information and audio information from said remote control; and
wherein said media management module is to establish a call connection between said telephone and said media management module, and communicate audio information using said call connection.

17. The system of claim 15, wherein said telephone interface is to receive a call request from a telephone over a telephone network, said television interface is to send an incoming call message to said display, said receiver is to receive a call accept message from said transmitter, and said media management module is to send a mute message to mute audio information from a television signal using said television interface.

18. The system of claim 15, wherein said media management module is to receive audio information from said telephone interface, and send said audio information to said speaker.

19. The system of claim 15, further comprising a graphics overlay module to connect to said media management module, said graphics overlay module to receive a video plane from a television signal by said television interface, generate an overlay plane with said incoming call message, blend said video plane with said overlay plane to form a blended frame, and send said blended frame to said display using said television interface.

20. The system of claim 15, wherein said receiver is to receive a call request from said remote control, said media management module is to send a mute message to mute audio information from said television signal and an outgoing call message to said display using said television interface, said media management module to further receive a call accept message from said telephone by said telephone interface and establish said call connection in response to said call accept message.

21. An article comprising:
a storage medium;
said storage medium including stored instructions that, when executed by a processor, are operable to receive a call request by a computer from a telephone over a telephone network, send an incoming call message to a display for a television system, receive a call accept message from a remote control for said television system, establish a call connection in response to said call accept message, send a mute message to mute audio information from a television signal, and communicate audio information using said call connection.

22. The article of claim 21, wherein the stored instructions, when executed by a processor, communicate using stored instructions operable to receive audio information at a microphone for said remote control, send said audio information to said computer using a transmitter, and send said audio information from said computer to said telephone.

23. The article of claim 21, wherein the stored instructions, when executed by a processor, communicate using stored instructions operable to receiving audio information at said computer from said telephone, sending said audio information to a speaker for said television system, and reproducing said audio information using said speaker.

24. An article comprising:
a storage medium;
said storage medium including stored instructions that, when executed by a processor, are operable to receive a call request by a computer from a remote control, send a mute message to mute audio information from a television signal, send an outgoing call message to a display for a television system, receive a call accept message from a telephone by said computer, establish a call connection in response to said call accept message, and communicate audio information using said call connection.

25. The article of claim 24, wherein the stored instructions, when executed by a processor, communicate using stored instructions operable to receive audio information at a microphone for said remote control, send said audio information to said computer using a transmitter, and send said audio information from said computer to said telephone.

26. The article of claim 24, wherein the stored instructions, when executed by a processor, communicate using stored instructions operable to receive audio information at said computer from said telephone, send said audio information to a speaker for said television system, and reproduce said audio information using said speaker.
